(19) United States
(12) Patent Application Publication
(10) Pub. No.: US 2006/0077403 A1
(43) Pub. Date: Apr. 13, 2006

(54) Optical system and method for measuring small dimensions

(76) Inventor: Shoaib Hasan Zaidi, Poughkeepsie, NY (US)

Correspondence Address: SLATER & MATSIL LLP, 17950 PRESTON ROAD, SUITE 1000, DALLAS, TX, 75252, US

(21) Appl. No.: 10/964,377

(22) Filed: Oct. 13, 2004

(51) Int. Cl. G01B 11/14

(52) U.S. Cl. 356/625

(57) ABSTRACT

Disclosed is system and method for measuring small integrated circuit features without destroying the wafer. A preferred embodiment comprises measuring the deviation from the characteristic refractive index of a wafer surface as indicative of the size of the circuit features. The method further comprises irradiating a plurality of the features, detecting emanating radiation with respect to the features, determining therefrom an effective index of refraction of the film and the features, and analyzing the effective index of refraction to determine the size of the features. Analyzing the effective index of refraction comprises comparing the effective index of refraction to an index of refraction of a film having therein features of a nominal feature size and determining the deviation of feature size based upon the comparing step.

### TECHNICAL FIELD

The present invention relates generally to semiconductor processing, and more particularly to a system and method for optical measurement of small dimensions.

### BACKGROUND

Measuring the dimensions of features for integrated circuits (ICs), such as dynamic random access memories (DRAMs), is a critical and difficult task that impacts the design, development and fabrication of ICs. Critical Dimensions (CDs) are the sizes of the smallest geometrical features, such as the width of interconnect lines, contacts or trenches, which can be formed during integrated circuit manufacturing using a given technology. Many current methods for measuring CDs either result in destruction of the wafer or produce very limited sampling of the feature sizes.

Critical Dimension Scanning Electron Microscopy (CD-SEM), for example, is often a destructive imaging method with a lateral resolution below 10 nm. A focused beam of electrons is scanned across a sample and an image is constructed based on the detection of secondary electron current. Two main types of measurements are employed: 1) top-down SEMs, used for linewidth measurements of features, and 2) cross-section SEM feature cross-section measurements. One key problem with SEMs is that of limited sampling. The technique is slow and therefore it is burdensome to measure a large number of features. Cross-section SEMs also entail the destruction of the sample under measurement, thereby limiting the usable or marketable product.

Atomic Force Microscopy (AFM) is another method that is capable of surface visualization with near-atomic resolution. AFM provides a measurement of the roughness of solid surfaces based on electrostatic interactions between the surface and the measuring tip. The measuring tip can be set above the surface, on the surface, or can tap the surface, oscillating at high frequency (tapping mode). However, if the openings of the features are small and the depths deep, AFM tips may not be able to reach into them. Commonly, sidewall angles for these high-aspect features are measured from cross-section SEM images. This requires cleaving and destruction of the wafer. This technique is also plagued with limited sampling.

Many features of interest in integrated circuit manufacturing are difficult to measure by using AFMs or top-down CD-SEMs. This is because either the tip of the AFM is too large for the opening of the features or the collection angle for the secondary electrons is steep. There are many such parameters for which measurements are desired, such as sidewall angles and profiles and trench and various recess depths.

Nondestructive techniques such as ellipsometry and scatterometry are routinely used to measure material dimensions. One common problem with the analysis of signals from periodic structures is extracting useful information from complex spectra collected in measurements. The collected spectra are compared with mathematically modeled generated data from which the dimensions are inferred. Two common methods for modeling the interaction of light with periodic structures are Rigorous Coupled Wave Analysis and the Modal Method. The calculation time and the database size required for structures with periodicity in both directions are significantly greater than those required for structures with periodicity in one direction. Another problem encountered with scatterometric analysis of 3-D structures is an increase in incidence of non-unique solutions. Non-unique solutions are those where measured spectra match multiple physical grating profiles (when experimental noise is taken into account). This has limited the use of such optical technique for analysis of line-space patterns. Even so, considerable skill and effort are required to build accurate models and generate the reference spectra and to match measured data with these spectra.

Accordingly, there is a need for a method to enable access to small features of integrated circuits that is easy, less complicated, and does not result in the destruction of the wafer.

### SUMMARY OF THE INVENTION

These and other problems are generally solved or circumvented, and technical advantages are generally achieved, by preferred embodiments of the present invention that provide a method for measuring small dimensions of integrated circuit features. More specifically, embodiments of the present invention provide a method for measuring small integrated circuit features wherein the method comprises measuring the deviation from the characteristic refractive index of the wafer surface as indicative of the volume of the surface features.

In accordance with a preferred embodiment of the invention, a method for measuring features of an integrated circuit device on a wafer having a film comprises irradiating or illuminating a plurality of the features. It further comprises detecting emanating radiation with respect to the features, determining therefrom an effective index of refraction of the film and the features, and analyzing the effective index of refraction to determine the size of the features. Analyzing the effective index of refraction comprises comparing the effective index of refraction to an index of refraction of a film having therein features of a specific feature size and determining the deviation of feature size based upon the comparing step.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. One skilled in the art realizes that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a top-down, planar view of a rectangular portion of a wafer covered with a blanket film.

FIG. 2 is a top-down, planar view of a the blanket film of FIG. 1 further including a plurality of structures i.e. (DRAM cells) shown at an intermediate manufacturing step;

FIG. 3 is a top-down, planar view of two 8 F² cells of FIG. 2, wherein the cells comprise the blanket film and the mesas;

FIG. 4 is a block diagram illustrating a sequence of steps in accordance with a preferred embodiment for measuring small features of an integrated circuit;

FIG. 5 is a block diagram illustrating components of a system used to measure small dimensions; and

FIG. 6 is cross-sectional view of a preferred means for determining proper irradiating spot size.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely an optical method for measurement of small dimensions. The invention may also be applied, however, to other metrology methods. As used herein, small generally refers to less than approximately 1 micron, but those skilled in the art should realize that equivalent constructions for measuring larger features do not depart from the spirit and scope of the invention.

Features amenable to measurement using preferred embodiments include, by way of example, a cell, a mesa, a tunnel junction mesa, a trench, a transistor, a contact, a trench filled with polysilicon, an isolation space, and a film hole. Further examples include features of a patterned photoresist such as alternating lines and spaces, or stripes. As will become evident in the discussion of preferred embodiments, the wavelength of the sampling radiation may be much longer than the feature size of interest. These embodiments, therefore, will not become obsolete as device features continue to shrink. A further advantage of preferred embodiments is that they are rapid and inexpensive. Scanning electron microscopy, for example, can measure small device features, but this is expensive, time consuming, and limited in throughput. Optical microscopy suffers from the same limitations, but it is subject to additional limitations imposed by optical diffraction. Preferred embodiments can measure a statistically significant sample size in less than 1 minute using such routine equipment as an ellipsometer, a scatterometer, a reflectometer, or a FT-IR spectrometer.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) that is executed via the operating system. In addition, various other peripheral devices may be connected to the computer platform, such as an additional data storage device and a printing device. Techniques for computer controlled, optical measurement of semiconductor features are described in detail in a patent application by Zaidi et al., U.S. Pat. No. 2,003,0063272, which is hereby incorporated by reference.

It is to be further understood that, because some of the constituent system components and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

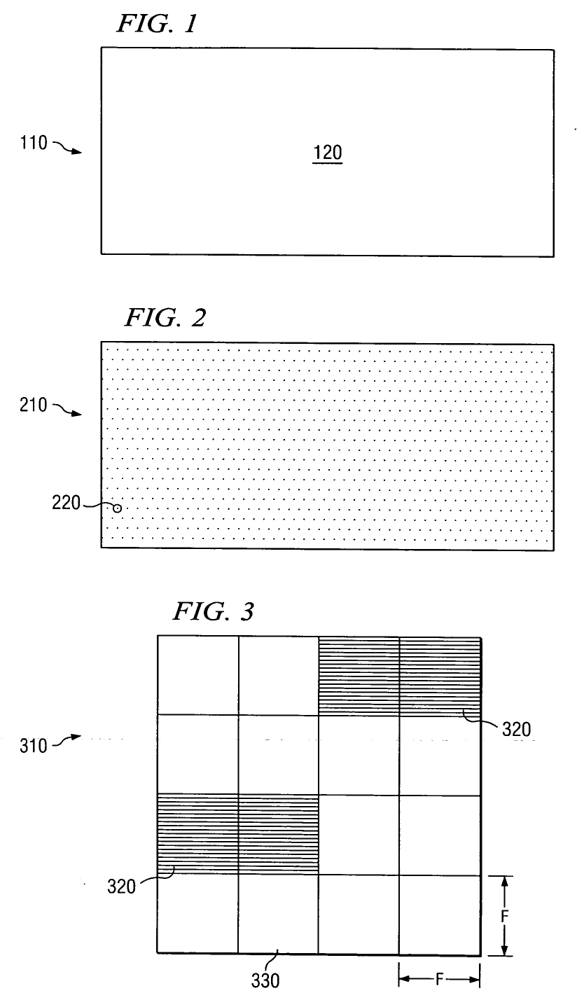

With reference now to FIG. 1, this is a top-down, planar view of a rectangular portion of a wafer with a blanket film having a known index of refraction.

FIG. 2 illustrates an intermediate step in the fabrication of an integrated circuit. By way of example, it can be a memory chip 210 comprising over one million discrete periodic structures 220 such as DRAM, and it is shown after one of a plurality of lithographic steps.

FIG. 3 illustrates two DRAM cells 310 in the midst of an intermediate fabrication step. Each cell has an 8 F² area, where F is the minimum line width of the feature size that can be patterned with lithography. As further shown in FIG. 3, the surrounding area is 4 times the cell area. Typically, a device cell may contain many submicron features including isolation trenches, contact holes, vias, intermetal dielectrics (IMDs), and mesas. FIG. 3 illustrates a plurality of features, in this case, four F by F mesas 320 in the blanket film 330. In accordance with preferred embodiments described herein, a method for measuring small features, such as mesas or a trench filled with polysilicon, is set forth in detail below.

Light is directed to a target and the reflected beam is measured by a detector. The optical measurements are taken from a patterned area of a wafer of a semiconductor device. The patterned area includes features of interest for which information corresponding thereto is desired. For example, the dimensions of a trench filled with polysilicon may be measured using the present invention. The optical measurements can be ellipsometric, scatterometric, reflectometric, polarimetric, or any combination of these or similar techniques, as are known to those of ordinary skill in the related art.

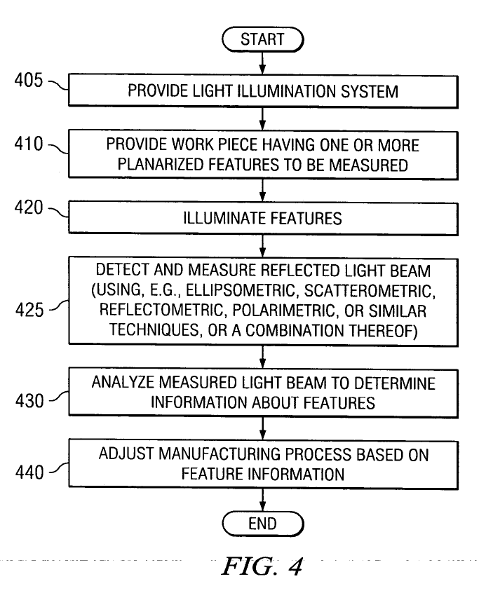

FIG. 4 is a flow diagram illustrating a method for optical measurement of small features according to an illustrative embodiment of the present invention.

In FIG. 4, block 405, a light illumination system is provided. It is to be appreciated that the present invention may be employed with many types of illumination systems, and thus, the present invention is not limited to any particular type of light illumination system. These systems are modified as described herein to provide the feature measurement capabilities as described in accordance with preferred embodiments.

In block 410, a work piece is provided, such as a semiconductor integrated circuit including many MOSFETs at an intermediate state of fabrication. The MOSFET includes a plurality of trenches filled with polysilicon features.

Using a semiconductor integrated circuit as a work piece is for illustrative purposes only, and it is not intended as a limitation. Embodiments described herein may advantageously measure periodic features about one micron or less on many types of work pieces with a film. For example, embodiments may find application in the manufacture of IR focal plane arrays, gamma ray imaging detectors, photovoltaic cells, flat panel displays, transparent and flexible substrates, in addition to semiconductor devices.

The illumination system provided in block 405 includes an exposure system and a detection system. In block 420, the features on the work piece are illuminated by the exposure system.

In block 425, the detection system is employed to detect and measure the light beam reflected by the features on the work piece. Block 425 may be performed using, for example, ellipsometric, scatterometric, reflectometric, polarimetric, or any combination of these or similar techniques, as are known to those of ordinary skill in the related art.

In block 430, the measured light beam is analyzed to determine information about the features. Such information may include, for example, size, grating composition, and so forth. However, a preferred objective is determining the dimensions of processing of key device features.

A number of methods can be used to analyze the light beam to extract the feature size. A preferred embodiment involves detecting emanating radiation with respect to the features and determining therefrom an effective index of refraction of the film. Determining the index of refraction of a film is well known to those in art as being amenable to ellipsometric, scatterometric, reflectometric, and polarimetric techniques. Feature size is extracted by comparing the effective index of refraction to an index of refraction of a reference film having therein features of a precisely measured size and determining the deviation of feature size based upon the comparing step.

The index of refraction of the reference or calibration film may be determined before or after the work piece. In preferred embodiments, features of the calibration film are precisely measured, such as with a SEM or ellipsometry, before manufacturing the work piece to enable rapid process control. A preferred means of comparing the effective index of refraction to nominal features is through the Bruggeman effective medium approximation theory.

Bruggeman theory provides that the effective index of a fraction mixed component thin film is approximated by the following relation: n_{eff}=(1−f₂)*n₁+f₂*n₂ where n_{eff} is the effective index of refraction of a two component thin film, n₁ and n₂ are the indices of refraction of the two components, and f₂ is the volume fraction of the second component. The feature size is extracted through straight forward algebraic manipulation of the measured effective index of refraction via the Bruggeman relation. For example, referring again to FIG. 3, consider the case where the blanket film has an index of refraction of 1.0, and the features within the film, in this case mesas, have a refractive index of 3.0. As shown in FIG. 3, there are two 8F² cells. With two F×F mesas per cell, the surface area coverage of the features is exactly 25% (i.e. 2/8). Through the Bruggeman relation, the effective index of refraction of the blanket film and the features is equal to 0.75*1.0+0.25*3.0=1.5.

Now consider the case where, perhaps as one occurring in an intermediate fabrication step, the desired features are 10% larger than their target specification. In this situation, the area of the features will be 2.2*1.1 units larger, or in an 8 F² cell design, 2.42/8 or 30.25% of the total surface area. Here, again using the Bruggeman relation, a measured index of refraction will be (1−0.3205)*1.0+0.3205*3.0=1.605. Comparing the second refractive index, 1.605, to the first, 1.500, provides a measure of the feature size.

The Bruggeman approximation used in preferred embodiments may be combined with conventional metrology methods to extract additional information regarding the features. For example, conventional methods such as ellipsometry, reflectometry, or FTIR, may measure film thickness or film refractive index when a blanket film 120, as in FIG. 1, has periodic structures 220, as in FIG. 2. In some manufacturing situations, there is an offset in film thickness between the blanket film 120 and the periodic structures 220. By measuring the offset using conventional means or estimating it using acquired data, one may calculate the film thickness in patterned areas using measurements of a blanket film. Affixing the value of the film thickness (to either a unique value or limiting to a suitable range) can greatly improve the fitting or estimation of the effective refractive index. There may be situations in which different combinations of film thickness and effective refractive indices produce spectra that are similar to measured spectra. More accurately measuring thickness can achieve a narrower and better estimate for the effective refractive index.

Referring again to FIG. 4, box 430, the step “analyze measured light beam to determine information about features,” is preferably accomplished using the Bruggeman relation as discussed above. It may further include building a database on prior measurements and then comparing it with the refractive index for nominal feature samples. Finally, block 440 is an optional process feedback step that includes compiling information from a statistically significant number of samples and correcting the process performance using statistical process control (SPC) methods well known to those skilled in process control.

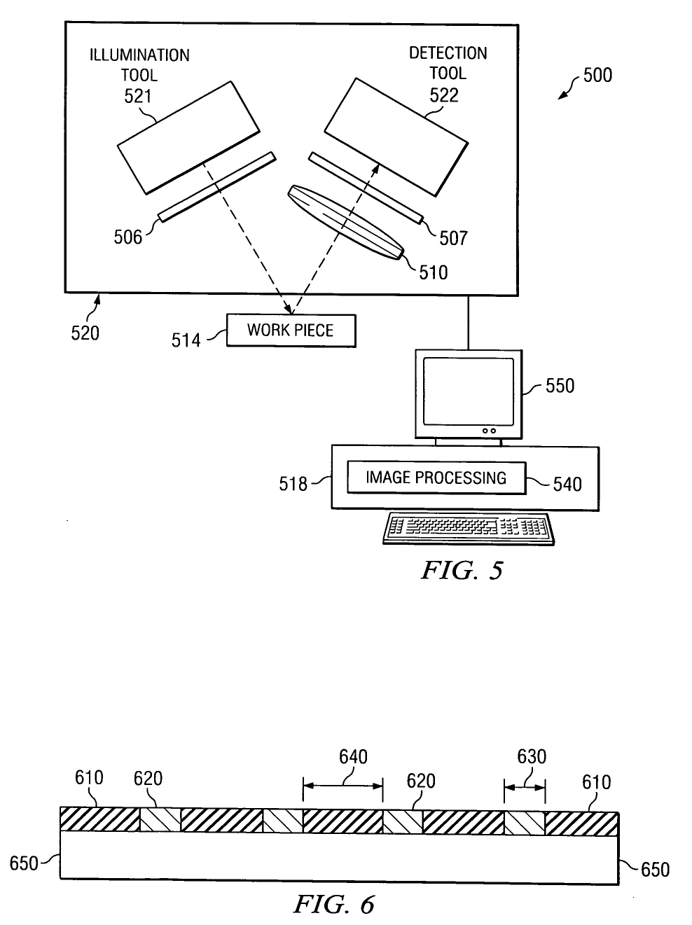

FIG. 5 is a block diagram illustrating a system 500 for optical measurement of small features, according to an illustrative embodiment of the present invention.

The system 500 includes an illumination system 520. The illumination system 520 includes an exposure or illumination tool (hereinafter “illumination tool”) 521 for providing light to illuminate a work piece 514. The illumination tool 521 may be, for example, a broadband illumination tool, a single wavelength illumination tool, or any other type of illumination or exposure tool.

Work piece 514 may include a semiconductor wafer including a plurality of die or a single integrated circuit having small features to be measured. Illumination tool 521 propagates a beam of radiation or light onto a plurality of features and the film of the work piece 514. The beam has a spot size formed by projection of the beam onto the work piece 514. In preferred embodiments, light from illumination tool 521 passes through a filter module 506 either before hitting the work piece 514 or it may pass through filter module 507 after being reflected from the work piece 514. Filter module 507 may be included at a detection tool 522 (included in illumination system 520) to filter light, which has been reflected from the work piece 514. The additional filter module 507 may be included in addition to or instead of the filter module 506. Filter modules may both be included to increase the number of available filters or to provide additional filtering. Given the teachings of the present invention provided herein, one of ordinary skill in the related art will contemplate these and various other configurations and alternations of the elements of system 500, while maintaining the spirit and scope of the present invention.

Detection tool 522 includes sensors for the detection of light reflected back from the small features on the work piece 514. Illumination and detection tools 521 and 522, respectively, may be the type commonly provided in illumination systems. Thus, it is to be appreciated that, for the sake of brevity, some components typically found in an illumination system are not shown and described but may nonetheless be included in illumination system 520, while maintaining the spirit and scope of the present invention. Such components may include, for example, an adjustable or variable aperture for the detection tool 522.

Lens 510 collects reflected light from the small features on the work piece 514. After collecting light reflected from the small features on the work piece 514, a computer processing system 518, having a processor program 540 stored thereon, is preferably employed to analyze the measured light. The computer processing system 518 may include a display 550 for displaying the results of the analysis.

FIG. 6 illustrates the criteria for selecting the proper illumination spot in relation to the feature to be measured in accordance with an illustrative embodiment of the present invention. FIG. 6 represents an intermetal dielectric (IMD) layer 610 deposited after a metal line 620 is patterned. As illustrative of embodiments described herein, an average lateral width 630 of the deposited metal line 620 is to be measured. By way of example, the lateral width 630 of the metal has a target value of 0.5 μm. There is a lateral distance 640 between each metal line 620 of 1.0 μm. In accordance with a preferred embodiment, an irradiating spot size should illuminate at least 10 features. In this case, an irradiating spot at least 15 μm is preferred. In this way, a single spot illuminates many features, and a good measure of the average feature size is obtained.

Through proper selection of irradiating spot size, alternative process control objectives are achievable. A large spot permits rapid measurement of the average feature size in minimal time. Alternatively, a smaller spot size, coupled with many samples, can yield useful information regarding the distribution of size variations in different regions of the device.

In further accordance with preferred embodiments, selecting target sample areas near the edge 650 the device is preferably avoided. If the illuminating spot lands between regions with periodic features and blanket regions, the effective index measured will be weighted by the proportion of the beam in any one region. To avoid this problem, the beam spot is preferably contained within a single region.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for measuring features of an integrated circuit device on a wafer having a film, the method comprising:
irradiating a plurality of the features using irradiating radiation having a wavelength and a spot size;
detecting emanating radiation emanating from the features and determining therefrom an effective index of refraction of the film; and
analyzing the effective index of refraction of the film to determine a size of the features.

2. The method of claim 1, wherein analyzing the effective index of refraction comprises comparing the effective index of refraction to an index of refraction of a reference film having therein features of a nominal feature size; and
determining a deviation of feature size based upon the comparing of the indexes of refraction.

3. The method of claim 1, wherein analyzing the effective index of refraction of the film to determine a size of the features further comprises a using a Bruggeman effective medium approximation.

4. The method of claim 1, wherein detecting emanating radiation is performed using at least one of an ellipsometric, a scatterometric, a reflectometric, FT-IR, and a polarimetric technique.

5. The method of claim 1, wherein the emanating radiation is at least one of reflected, scattered, emitted, and transmitted radiation.

6. The method of claim 1, wherein the features comprise at least one of a cell, a mesa, a tunnel junction mesa, a trench, a transistor, a contact, a trench filled with polysilicon, an isolation space, and a film hole.

7. The method of claim 1, wherein the wavelength is infrared.

8. The method of claim 1, wherein the wavelength is greater than the feature.

9. The method of claim 1, wherein the spot size covers at least 10 features.

10. The method of claim 1, wherein the features comprise a line and space pattern defined by a plurality of stripes of photoresist.

11. The method of claim 10, wherein the spot size covers at least 10 lines.

12. A method of manufacturing a semiconductor device, the method comprising:
forming a film of a first material;
forming features in the film, the features having a feature size that deviates from a nominal size, the features being formed of a second material;
illuminating the film and the features;
analyzing light reflected from the film and the features and determining therefrom an index of refraction of the film and the features;
comparing the index of refraction of the film and the features to an index of refraction derived from a known film having formed therein nominal features of the nominal size; and
determining a deviation from a nominal feature size based upon the comparing.

13. The method of claim 12, wherein the index of refraction of the film and the features is empirically derived.

14. The method of claim 12, wherein the index of refraction of the film and the features is derived based upon a relative nominal area of the features and from a refractive index of the first material and a refractive index of the second material.

15. The method of claim 12, further comprising adjusting at least one parameter for forming features in the film in response to the step of determining a deviation from a nominal feature size.

16. The method of claim 12, wherein the deviation from a nominal feature size is zero.

17. A system for measuring features of a workpiece having a film, the system comprising:
an illumination tool for illuminating the features and the film using radiation having a wavelength and a spot size;
a detection tool for detecting a reflected light with respect to the features and the film, wherein the detection tool determines an effective index of refraction of the features and the film based upon the reflected light; and
a processor for determining a feature size based upon the effective index of refraction of the features and the film and an index of refraction of a reference film having thereon precisely measured features.

18. The system of claim 17, wherein the detection tool further comprises at least one of an ellipsometric, a scatterometric, a reflectometric, FT-IR, and a polarimetric device.

19. The system of claim 17, wherein the processor uses a Bruggeman effective medium approximation for determining the feature size.

20. The system of claim 17, wherein the features comprise at least one of a cell, a mesa, a tunnel junction mesa, a trench, a transistor, a contact, a trench filled with polysilicon, an isolation space, and a film hole.

21. The system of claim 17, wherein the wavelength is infrared.

22. The system of claim 17, wherein the wavelength is greater than the feature.

23. The system of claim 17, wherein the spot size covers at least 10 features.

24. The system of claim 17, wherein the features comprise a line and space pattern defined by a plurality of stripes of photoresist.

25. The system of claim 24, wherein the spot size covers at least 10 lines.

26. The system of claim 17, wherein the work piece comprises an IR focal plane array, a gamma ray imaging detector, a photovoltaic cell, a flat panel display, a substrate, an integrated circuit, or a semiconductor device.
